(19) United States
(12) Patent Application Publication
(10) Pub. No.: US 2026/0207428 A1
(43) Pub. Date: Jul. 23, 2026

(54) IMPROVED DISTRICT NORMOBARIC OXYGEN THERAPY APPARATUS

(71) Applicant: OXYVIX S.R.L., Maniago (PN) (IT)

(72) Inventor: Jean Claude VIXAMAR, Westland, MI (US)

(73) Assignee: OXYVIX S.R.L., Maniago (PN) (IT)

(21) Appl. No.: 19/144,164

(22) PCT Filed: Dec. 28, 2022
(86) PCT No.: PCT/IT2022/000059

§ 371 Date: Jun. 27, 2025

(51) Int. Cl. A61H 35/00

(52) U.S. Cl. CPC A61H 35/006; A61H 2201/105; A61H 2201/5082; A61H 2201/5089

(57) ABSTRACT

A normobaric oxygen therapy apparatus or normobaric chamber that is efficient for the treatment of injuries. A district oxygen therapy apparatus including a normobaric treatment chamber equipped with a saturation system.

### TECHNICAL FIELD OF THE INVENTION

The present invention relates to a normobaric oxygen therapy apparatus or normobaric chamber especially efficient for treating injuries. Specifically, the invention relates to a district oxygen therapy apparatus comprising a normobaric chamber for treating upper or lower limbs of the human body equipped with an evolved saturation system.

### STATE OF THE PRIOR ART

Trophic lesions in the lower limbs are a very common condition nowadays (about 6% of people over 65 years old). To treat such trophic lesions, there are few therapies currently in use. One of the most widely used therapies is hyperbaric chamber oxygen therapy. Nevertheless, the hyperbaric chamber has various contraindications, both medical and economic.

For this reason, attempts have been made to overcome these contraindications by using oxygen therapy localized only to the limbs, particularly the lower limbs. In past years, such therapy was implemented by more or less empirical and therefore never scientific and repeatable methods in the same manner. The lower limb with the lesion was placed in a plastic bag, closed around the thigh or leg with a patch, and a plastic tube was introduced into that bag, which introduced oxygen. This method was not scientific and was unreliable being handmade. Moreover, effectively the results were not measurable because they were variable based on many factors resulting from the very crude methodology.

In 2002, a utility model patent application (ITTV20020016U1) was filed in Italy for a device called the “District Hyperbaric Chamber.” Such a device, while having scientific validity in that it measures the amount of oxygen inside the device itself and the humidity, cannot intervene to keep the pressure constant so that it does not exceed a pressure considered a threshold for the pathology to be treated.

A transparent plastic device suitable for containing the distal part of a lower limb and characterized by the fact that oxygen introduced by an ad hoc dispenser is maintained at a constant concentration of 95 percent and at a pressure of 1 mm Hg greater than atmospheric pressure by means of a diaphragm valve was therefore envisioned. Such a device allows a constancy of oxygen delivery and concentration combined with a constant pressure. This device is described in Italian Patent No. 1380897.

Although the latter device has been found to be practical and has given positive responses to treatments of limb injuries, it has been seen that the time and quality of wound healing still turn out to be on the one hand too long and on the other hand unsatisfactory from the point of view of complete wound healing. It has also been observed a considerable consume of oxygen with the consequence of high costs for buying the related cylinders.

In addition, the dispenser employed is a cannula that extends into the chamber with a terminal cone to direct the flow of oxygen to the wound in a precise manner. This type of dispenser, however, concentrates the treatment only on a specific point of the wound, while usually wounds are quite extensive. In addition, there is a risk of shock of the limb against the cannula, especially of the wound against the terminal cone.

### SUMMARY OF THE INVENTION

Thus, the technical problem underlying the present invention is to provide an apparatus for district oxygen therapy under normobaric conditions such that long treatment times and incomplete wound healing are avoided.

This problem is solved by an apparatus for district oxygen therapy under normobaric conditions in which treatment conditions are improved.

A first object of the invention is an oxygen therapy apparatus comprising a novel oxygen delivery system.

A second object is an apparatus capable of increasing the quality of wound healing.

A further object is apparatus capable of decreasing the treatment time to achieve wound healing.

A still further object is a piece of apparatus in which the new delivery system is easy to produce and inexpensive to manufacture.

A not-quite-so-further object is apparatus that is free of shock hazards against cannulas protruding inside, cannulas that then must be sterilized for reuse or discarded if they come in contact with wounds in such cases.

### BRIEF DESCRIPTION OF THE FIGURES

Further features and advantages of the district oxygen therapy apparatus under normobaric conditions of the present invention will become more apparent from the following description of an embodiment given by way of non-limiting example only with reference to the following figures, wherein:

FIG. 1 represents a general perspective and rear view of the apparatus according to the present invention;

FIG. 2 represents a front perspective view of the partially open device of FIG. 1;

FIG. 3 represents a top plan view of the FIG. 1 device without oxygen inlet means;

FIG. 4 represents a perspective top view of inlet means of the apparatus of the invention;

FIG. 5 represents a plan view of the interior of the invention's inlet means of FIG. 4;

FIG. 6 represents a cross-sectional view along line VI-VI of the spreading means of FIG. 4;

FIG. 7 represents a schematic side view of a drug drip device;

FIG. 8 represents a schematic side view of a drug nebulizer device.

### DETAILED DESCRIPTION OF THE INVENTION

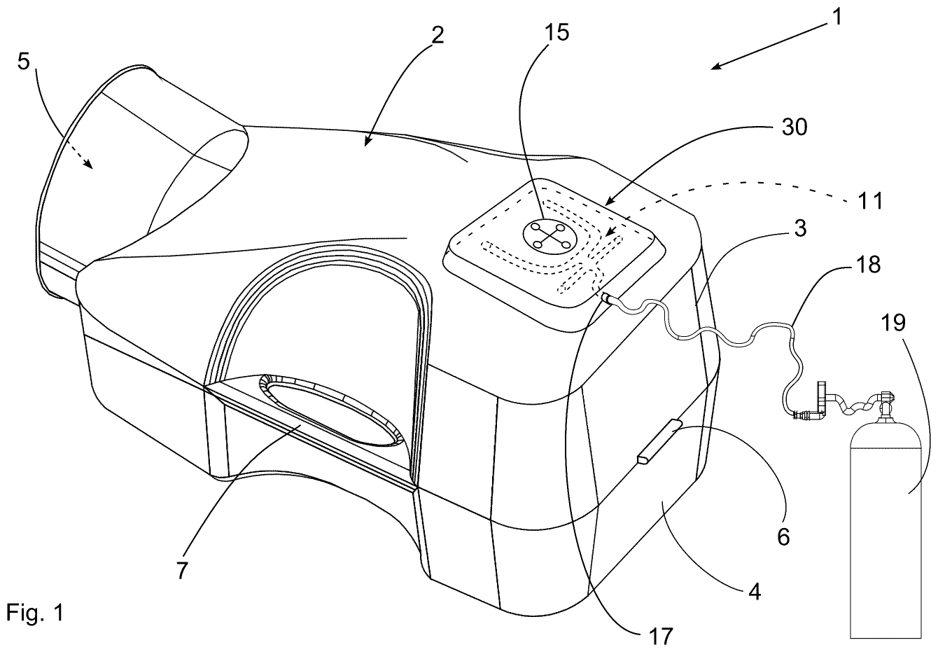

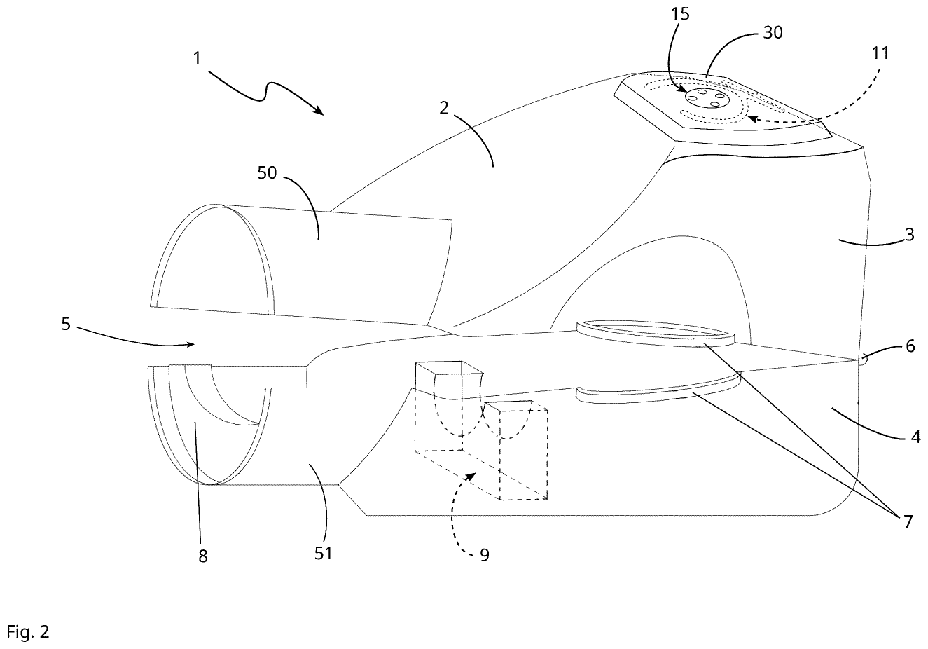

With reference to FIGS. 1 and 2, reference number 1 generally indicates a district oxygen therapy apparatus under normobaric conditions. Apparatus 1 comprises a normobaric chamber 2 consisting of a first half-shell 3 positioned superiorly to close a second half-shell 4, except at an opening 5 for passage of a limb to be treated. Preferably, the opening 5 is positioned on an front side of the chamber, while on the rear side a hinge 6 liftable connects the first half-shell 3 with the second half-shell 4.

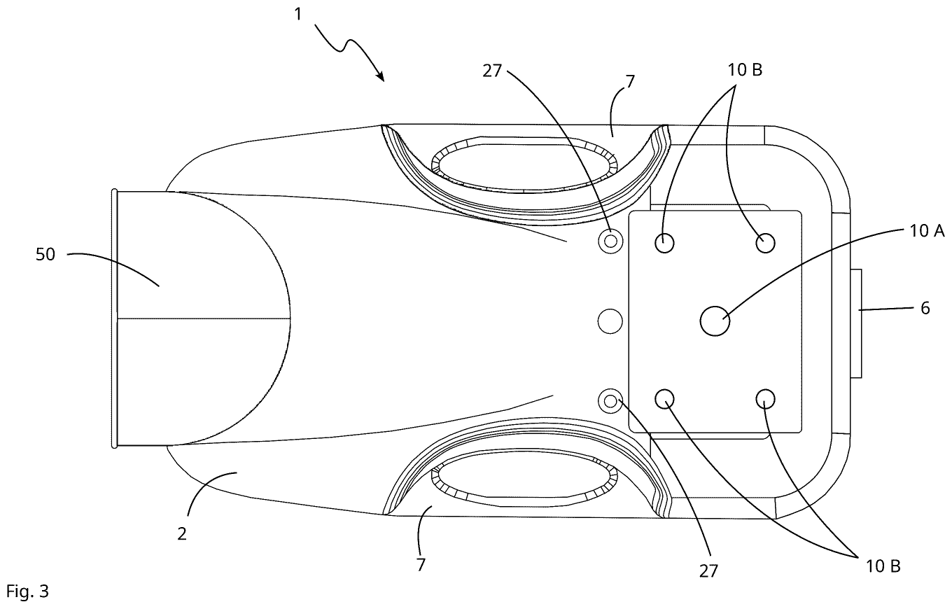

In particular, chamber 2 appears to be hermetically sealable, except at said opening, along the respective contact edges of the two half-shells first 3 and second 4 by means of, for example, snap-in engagement and/or corresponding sealing gaskets (not shown). Preferably, the first 3 and second 4 half-shells are constructed of transparent plastic material such as polycarbonate. In addition, two handles 7 (FIG. 3), one on each of the opposite sides of the chamber 2, are provided along said contact edges of the half-shells to facilitate gripping and carrying the apparatus itself.

Preferably, the opening 5 is bounded by two substantially mirrored, semicircular portions 50, 51, each being part of the first 3 and second 4 half-shells. Internally to the semicircular portion 51 of the second half-shell 4, a semicircular antidecubitus cushion 8 is positioned to provide comfortable support of the proximal part of the limb introduced into the treatment chamber 2 (FIG. 2). In addition, an additional cushion 9 (FIG. 2) is placed on the bottom of the second half-shell 4 to make comfortable support of the distal part of the limb inside chamber 2.

The first half-shell 3 is then provided with a first through-hole 10A (FIG. 3) for venting excess oxygen from chamber 2. Advantageously, the first half-shell 3 includes means of oxygen delivery 11 within chamber 2 (FIGS. 1 and 2). These means are a homogeneous oxygen distribution device so as to achieve saturation. Specifically, the device includes a plurality of oxygen distribution channels 22. These channels are housed in a portion 30 of the first half-shell 3 (FIGS. 1 and 2) and are such as to receive oxygen from an external source and inject it into the chamber 2 in a diffuse manner so as to achieve the aforementioned saturation in a short time.

In accordance with a form of embodiment of the invention, a plurality of second holes 10B (FIG. 3) are preferably arranged near and around said first hole. The second holes, as explained below, are such as to be engaged by said channels 22 of distribution or diffusion of the oxygen fed into the chamber 2.

In particular, according to a preferred embodiment of the invention, said diffusion device 11 consists of a single body conformed in the guise of a lid and adapted to be affixed to the first half-shell 3 to cover the aforesaid first holes 10A and second holes 10B.

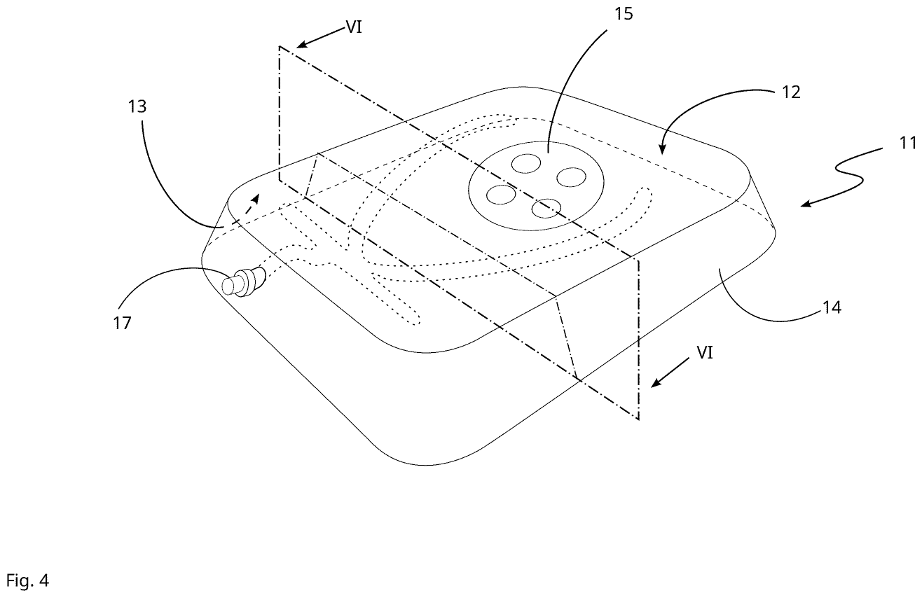

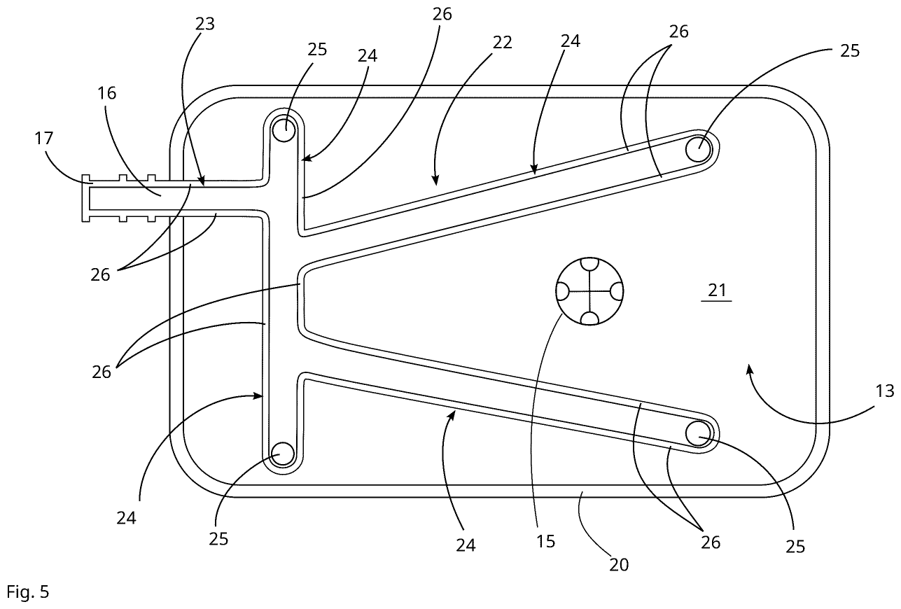

As shown in FIGS. 4 to 6, the lid 11 preferably has a general quadrangular shape with a first face 12 substantially flat and facing opposite said first half-shell 3, a second face 13 opposite said first face and a perimeter edge 14 connecting said first and second faces. The first and second faces are then traversed by a through-hole (not shown) engaged by means 15 of maintaining normobaric pressure. Preferably said means are a valve, more preferably a diaphragm valve calibrated to open elastically when the pressure of the gas fed into the chamber exceeds the value of the atmospheric pressure surrounding the environment in which the apparatus is located. In addition, the perimeter edge 14 includes a through-hole 16 (FIG. 5) connected with a connector 17 for engagement with an oxygen delivery tube 18 from an oxygen delivery device 19 (FIG. 1).

The second face 13 of the lid (FIG. 5) comprises a profile 20 of the perimeter edge 14 suitable for resting on and attaching tightly to the outer surface of the first half-shell 3, and a bottom 21 suitable for housing a plurality of channels 22 for distributing or diffusing oxygen from said connector 17 to diffuse oxygen into the chamber 2 in order, as explained, to rapidly reach saturation. Specifically, the channels 22 extend parallel to the plane of the bottom 21 so as to receive the flow of oxygen coming from the connector via a first branch 23 from which second branches 24 each destined to terminate with a corresponding end 25 open orthogonally with respect to the bottom 21 and positioned to coincide with one of said second through holes 10B of the first half-shell 3.

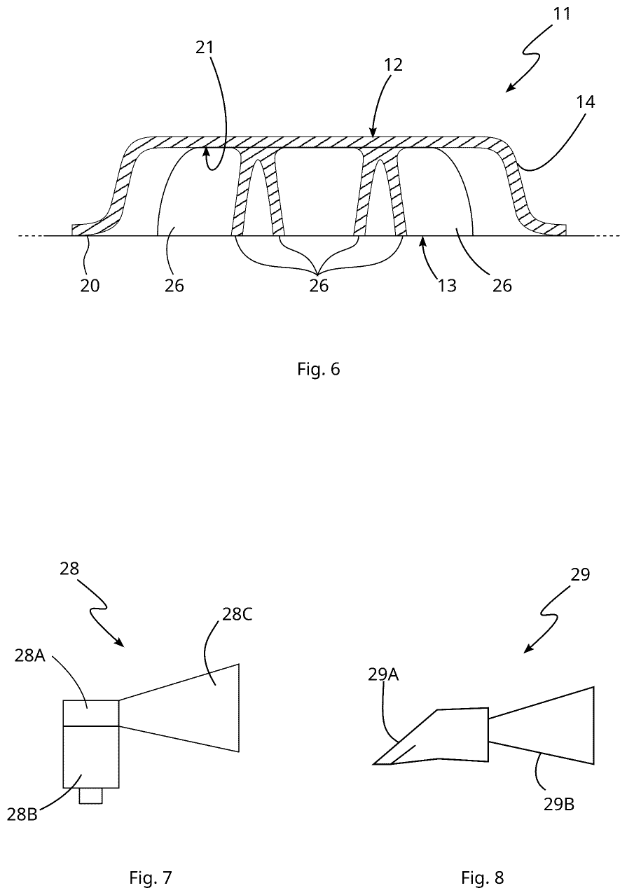

In accordance with an embodiment, the channels 22 are open, i.e., they are longitudinally sectioned cylinders in one piece with the bottom 21, projecting from said bottom so as to have an opening facing opposite the bottom itself and whose longitudinal edges 26 are in the same plane as the profile 20 of the perimeter edge 14 of the lid 11 (FIG. 6). In this way, when the lid is fixed on the half-shell 3, the channels 22 are sealed off from the surface of the half-shell itself, while the ends 25 allow oxygen to pass through the holes 10B of the first half-shell 3.

Ends 25 with corresponding holes 10B are preferably at least three and arranged as far apart as possible so as to achieve as uniform a distribution of oxygen within the chamber as possible. For example, with reference to FIG. 5, channels 22 are branched so as to carry oxygen to four points distributed at the four corners of the lid. In any case, other configurations are possible always with the aim of rapidly and homogeneously diffusing oxygen into the chamber and achieving optimal saturation.

In accordance with a first variant of embodiment, the above-mentioned channels 22 may be tubes fixed, preferably in a removable manner, on the bottom 21 of the lid 11 or on the inner supraface of the first half-shell 3. Therefore, the tubes run along the bottom until they open at the above prefixed positions corresponding to the through holes 10B of the first half-shell 3. In particular, the tubes can be fixed by gluing or molding or again they can be fixed by reversible interlocking in special locations (not shown) formed, for example, by elastic retaining tabs. Alternatively, the inner surface of said portion 30 of the first half-shell 3 may directly comprise said glued, molded, or removably attached tubes.

In accordance with a second variant embodiment, the diffusion device 11 comprises an oxygen flow diverter valve (not shown) connected on one side directly with the manifold 17 and on the other side with said plurality of channels 22. In this way, the valve advantageously enables homogeneous distribution of oxygen from a single duct without pressure drop.

Preferably, in addition, channel ends 25 or holes 10B of the first half-shell 2 are fitted with dispensing nozzles (not shown) that can be oriented within chamber 2 to distribute the gas in an even more controlled manner. Such nozzles can be atomizers.

Oxygen is supplied by a device 19 comprising a conventional pressurized cylinder usually connected to a humidifier (not shown) having a container of sterile water that is bubbled with said oxygen. This device is then connected to said lid 11 or first half-shell 3 with a conduit 18. The device 19 may also be provided with a manually closable or electronically controllable shut-off valve to regulate or shut off the flow and pressure of oxygen. The electronic control can be mounted on said device 19, either along conduit 18 or in a special housing (not shown) cut into the bottom 21 of lid 11 or first half-shell 3.

Regardless of placement, instrumentation and controls necessary for the control of oxygen concentration, humidity, temperature, and for time measurement using timers may be provided to accompany the apparatus of the present invention.

In accordance with a further variation, the apparatus includes at least one drug delivery device associated with one of said holes 10B of the chamber 2 or one or more additional dedicated holes 27, preferably formed in a portion of the half-shell 2 not covered by the lid 11. Specifically, the device is represented by a dripper 28 (FIG. 7) or a nebulizer 29 (FIG. 8).

The dripper 28 (schematized in FIG. 7) is a conventional device provided with reservoir 28A for a drug with corresponding outlet hole 28B. The dripper could also be connected to one end 25 of an oxygen delivery channel 22 through an engagement 28C.

Similarly, the entirely conventional nebulizer 29 (schematized in FIG. 8) includes a 29A nozzle associated with a drug holding tank (not shown). Alternatively, it may include an engagement 29B for connection with an end 25 of an oxygen delivery channel 22.

It should be noted that setting up the dripper or nebulizer also allows the lesion to be treated pharmacologically, in addition to oxygen treatment.

The apparatus 1 of the invention may then comprise a sleeve (not shown) made of fabric to wrap around the two portions 50, 51 bordering the opening 5 of the chamber 2 and extending to also cover part of the limb exiting the chamber when closed. In this way, as explained later, a seal is provided against unwanted oxygen leakage.

In accordance with a still further form of embodiment, the aforementioned lid 11 could have the openings 25 of engagement with the second holes 10B, conformed in the shape of pegs (not shown) that are cylindrical, hollow, and provided with a bulge to make a snap fit past the holes themselves. The profile of the perimeter edge 14 of the lid 11, moreover, could be covered with a rubbery plastic material so as to be squeezed tightly onto the first half-shell 3 when the aforementioned interlocking of the pegs takes place.

Furthermore, it is possible to connect an oxygen concentrator to the nozzle so as to obtain saving of the consumption and, as a consequence, of money for buying the cylinders.

In the development countries, the oxygen nozzle of the normobaric chamber of the invention can be connected to an electric accumulator battery charged by a photovoltaic apparatus.

The operation of the apparatus according to the present invention will now be described.

First, with the two half-shells first 2 and second 3 spread apart, for example, a lower limb is introduced into chamber 2 by resting the heel on pillow 9. Next, the chamber is closed around the leg or thigh resting on the semicircular antidecubitus cushion 8. The closure is airtight and is maintained so, in addition to the engagement between the edges of the two half-shells first 2 and second 3, by the above-mentioned fabric sleeve being closed around the limb with, for example, Velcro tape, so that the closure is gentle but complete. Through the diffusion device 11 connected with the delivery device 19, humidified pure oxygen is introduced. The oxygen concentration and atmospheric pressure is kept constant through the diaphragm valve 15. In this way, a 95% oxygen concentration is created and maintained within the chamber with a pressure that is no more than 1 mm Hg above atmospheric pressure so as not to create venous and lymphatic compression to the treated limb.

Depending on the pathology, and thus the therapeutic indication, either the dripper or the nebulizer is activated. It will be up to the health care provider to decide whether to connect either device and the type of drug to be brought to the lesion based on the pathology and etiology of the lesion. In this way, there is the effect of normobaric oxygen therapy and vasoactive therapy directly on the lesion itself.

Simultaneously, the temperature, pressure, humidity, and timer control and monitoring systems located in the lid 11 housing are activated. Through one or more sensors, corresponding parameters such as temperature, pressure, humidity, and treatment time are detected. This allows the sanitarian to constantly monitor treatment conditions and be able to intervene with adjustments according to specific needs.

It has been observed that by setting up a diffusion device such as the one described above, the homogeneous distribution of the gas makes it possible to achieve saturation of the entire treatment chamber in a very short time with the advantage of speeding up the healing process and at the same time improving the quality of healing in terms of wound healing, as reported later by the experimental comparison data. This means cost and consumption savings in both energy and treatment oxygen. Not only that, the apparatus turns out to be free of protruding cannulas that are dangerous due to impact with wounds and in any case are parts that must be thoroughly cleaned or replaced from time to time.

In any case, the apparatus of the invention has proved very effective in treating for example: complex wounds with bacterial or fungal over-infection, diabetic sores, arteriopathic, phlebopathic and mixed sores, soft tissue injuries in subjects undergoing corticosteroid treatment for chronic disabling conditions, skin transplants at risk of taking root due to local or general conditions, burns, infected bone injuries or exposed bone fractures. Injuries can be in both upper and lower extremities.

### Effects and Results of Using the Oxygen Therapy Apparatus of the Invention

### Example 1

A subject suffering from phlebopatic sore was treated with the apparatus of the present invention. Specifically, the limb was placed in the chamber resting on the two cushions. The first half-shell 3 was closed on the second half-shell 4 and the sealing cloth was applied with Velcro tape around the portion of the limb protruding from the chamber. A treatment time of 60 daily minutes was set, oxygen delivered at 95% with humidity not less than 50% and temperature between 15° and 25° C.

After the set time of 12 weeks, total wound healing was observed.

Similar treatment with same conditions with apparatus according to the known technique equipped with a cannula and subject with identical pathology, resulted in 70% wound healing in 24 weeks.

### Example 2

A subject suffering from chronic healing of a diabetic foot was treated with the apparatus of the present invention. Specifically, the limb was placed in the chamber resting on the two cushions. The first half-shell 3 was closed on the second half-shell 4 and the sealing cloth was applied with Velcro tape around the portion of the limb protruding from the chamber. A treatment time of 60 daily minutes was set, oxygen delivered at 95% with humidity at not less than 50%, temperature between 15° and 25° C.

After the set time of 15 weeks, total wound healing was observed.

Similar treatment with same conditions with apparatus according to the known technique equipped with a cannula and subject with identical pathology, resulted in 75% wound healing in 10 months.

1. An apparatus for normobaric oxygen therapy comprising a treatment chamber provided with a first half-shell closable on a second half-shell defining an opening for engagement with a portion of a limb, means for delivering oxygen into the chamber, wherein the means of introduction consists of a diffusion device comprising a plurality of channels provided with ends for delivering oxygen into the chamber so as to rapidly reach saturation.

2. The apparatus according to claim 1, wherein the plurality of channels is housed into a portion of the first half-shell, the portion comprising a hole for engaging a connector for connecting to a device for delivering oxygen.

3. The apparatus according to claim 2, wherein the portion of the first half-shell is a unique body as a lid sealed onto the first half-shell.

4. The apparatus according to claim 2, wherein the lid includes a first face substantially flat and facing opposite the first half-shell, a second face opposite the first face and a perimeter edge connecting the faces, wherein the edge includes the hole engaged by the connector for engagement with an oxygen delivery tube and the second face comprises the plurality of channels.

5. The apparatus according to claim 4, wherein the first half-shell comprises a first hole for venting excess oxygen from the chamber and a plurality of second holes connecting with the ends of the channels, the first and second holes being covered by the lid.

6. The apparatus according to claim 5, wherein the first and second faces of the lid are traversed by a through-hole engaged by means of maintaining atmospheric pressure.

7. The apparatus according to claim 4, wherein the channels are integral with the second face of the lid and are longitudinally closed when the lid is fixed on the first half-shell.

8. The apparatus according to claim 1, wherein the channels are fixed or removably applied tubes on an inner face of the first half-shell.

9. The apparatus according to claim 1, further comprising a valve for diverting oxygen flow from outside the chamber and a plurality of oxygen delivery nozzles in the chamber connected with the end of each channel.

10. The apparatus according to claim 9, wherein the dispensing nozzles are atomizing nozzles.

11. The apparatus according to claim 2, wherein the portion of the first half-shell further comprises means for reversibly restraining the channels and possibly the oxygen flow diverter valve.

12. The apparatus according to claim 1, further comprising instrumentation to control and monitor parameters relating to oxygen concentration, humidity, temperature, treatment time.

13. The apparatus according to claim 1, further comprising a drug delivery device selected from a drug dripper and/or a drug nebulizer.
